(19) United States
(12) Patent Application Publication
(10) Pub. No.: US 2025/0368138 A1
(43) Pub. Date: Dec. 4, 2025

(54) COVERING SHELF FOR VEHICLE AND VEHICLE COMPRISING THE SAME

(71) Applicants: HYUNDAI MOTOR COMPANY, SEOUL (KR); KIA CORPORATION, SEOUL (KR)

(72) Inventors: Jin Seok Yoon, Hwaseong-si (KR); Jae Eun Chang, Hwaseong-si (KR); Han Saem Choi, Hwaseong-si (KR)

(73) Assignees: HYUNDAI MOTOR COMPANY, SEOUL (KR); KIA CORPORATION, SEOUL (KR)

(21) Appl. No.: 18/968,144

(22) Filed: Dec. 4, 2024

(30) Foreign Application Priority Data
May 30, 2024 (KR) 10-2024-0070743

(51) Int. Cl. B60R 5/04

(52) U.S. Cl. CPC B60R 5/045

(57) ABSTRACT

A covering shelf which is supported and installed in a position that is spaced apart by a set height from a floor in a rear space of a rear seat in a vehicle. The covering shelf includes a main body configured to be extended in forward, backward and left and right directions to divide the rear space into upper and lower parts, and a flap configured to be extended from the main body toward the rear seat and rotatably installed on the main body.

### CROSS REFERENCE TO RELATED APPLICATIONS

The present application claims priority to Korean Patent Application No. 10-2024-0070743, filed on May 30, 2024, the entire contents of which is incorporated herein for all purposes by this reference.

### TECHNICAL FIELD

The present disclosure relates to a covering shelf for a vehicle and a vehicle including the same.

### BACKGROUND

Typically, hatchback type vehicles do not have a separate trunk room, unlike notchback type vehicles, and instead use the space between the rear seat and the tailgate as a trunk room.

A hatchback type vehicle may be equipped with a covering shelf that blocks the space in the trunk room when the tailgate is opened and closed.

The covering shelf is generally extended with the front end facing the rear seat and the rear end facing the tailgate, and is installed on both side surfaces to be engaged with the luggage side trim forming the wall surface of the vehicle interior by hinge engagement.

The rear seat may have a tilting backrest, and a certain gap is required between the covering shelf and the rear seat to allow such tilting.

However, items stored under the shelf may be visible from the outside through the gap between the rear seat and the covering shelf, which may be a problem leading to theft.

### SUMMARY

Various aspects of the present disclosure are directed to providing a covering shelf capable of blocking a gap with a rear seat while allowing tilting of a rear seat.

Various aspects of the present disclosure are directed to providing a covering shelf that is deformable according to the tilting of the rear seat and can block the gap.

According to an embodiment of the present disclosure, there is provided a covering shelf which is configured to be supported in a position spaced apart by a predetermined height from a floor in a rear space behind a rear seat in a vehicle, the covering shelf comprising a main body configured to be extended in forward, backward and left and right directions to divide the rear space into upper and lower parts, and a flap extended from the main body toward the rear seat and rotatably mounted on the main body.

Here, the covering shelf may further include a hinge configured to be installed in the main body and rotatably support the flap.

Here, the covering shelf may further include an elastic means configured to provide restoring force as the flap rotates.

Here, the elastic means may be wound in a spiral shape around the hinge, one end of the elastic means being supported by the main body to prevent rotation, and the other end of the elastic means including a torsion spring that is configured to rotate together with the flap.

Here, the flap may include at least one extension part which is allowed to be drawn in and out in the left to right directions from the flap.

Here, the at least one extension part may include a first extension part which is allowed to be drawn in and out in a first direction from the flap, and second extension part which is allowed to be drawn in and out in an opposite direction of the first direction from the flap.

Here, the flap may include a slot extending in the left-right direction, and the at least one extension part may include a lever exposed through the slot.

Here, the flap may further include a fixing means for fixing the flap in a state that the flap is rotated under the main body and folded.

Here, the fixing means may include a push-push latch including a gripper provided at one of the main body and the flap, and a hooking rod provided at the other of the main body and the flap to be gripped or released by the gripper.

Here, the fixing means may include a magnet provided at one of the main body and the flap, and a magnet or magnetic body provided at the other of the main body and the flap.

Here, the main body may include a hinge protrusion that is rotatably connected to a vehicle body inside the vehicle in both the left and right directions.

According to an embodiment of the present disclosure, there is provided a vehicle comprising a covering shelf which is supported in a position spaced apart by a predetermined height from a floor in a rear space of a seat inside a vehicle, wherein the covering shelf comprises a main body extended in forward, backward and left and right directions to divide the rear space into upper and lower parts, and a flap extended from the main body toward the seat and rotatably mounted on the main body, the flap including at least one extension part that is allowed to be drawn in and out in the left or right direction.

Here, the at least one extension part may include a first extension part which is allowed to be drawn in and out in a first direction from the flap, and second extension part which is allowed to be drawn in and out in an opposite direction of the first direction from the flap.

Here, the flap may include a slot extending in the left-right direction, and the at least one extension part includes a lever exposed through the slot.

Here, the vehicle may further include a luggage side trim configured to define a boundary surface at one side of the rear space and including a protrusion protruding toward an inside of the rear space. Here, the covering shelf may be positioned to be flat with an upper surface of the protrusion.

Here, the extension part may be drawn out to a front side of the protrusion to be flat with an upper surface of the protrusion.

Here, the seat may include a tiltable backrest.

According to an embodiment of the present disclosure, the deformation amount may be varied depending on the degree of tilting of the rear seat to block the gap with the rear seat.

This allows for the storage items to be visually blocked from the outside through the gap between the rear seat and the covering shelf.

### BRIEF DESCRIPTION OF THE FIGURES

FIG. 1 illustrates a covering shelf according to an embodiment of the present disclosure.

FIG. 2 shows the underside of the covering shelf of FIG. 1.

FIG. 3 shows the covering shelf of FIG. 1 installed inside a vehicle.

FIG. 4 shows a state in which the flap in the covering shelf of FIG. 1 is folded under the main body.

FIGS. 5 and 6 illustrate usage states of the covering shelf of FIG. 1.

### DETAILED DESCRIPTION

Since various modifications may be applied to the present disclosure and there may be various embodiments, specific embodiments will be illustrated in the drawings and described in the present disclosure. However, this is not intended to limit the present disclosure to specific embodiments and should be understood to include all changes, equivalents or substitutes included in the spirit and technical scope of the present disclosure.

Suffixes “module” and “part” used herein are only used for the name distinction between components, and should not be interpreted as having a premise of physicochemical classification or separation.

Terms including ordinal numbers such as “first” and “second” may be used to explain various components, but the components are not limited by the terms. The terms may be used only in a name for distinguishing one component from another component, and the sequence between them is recognized by the context of the description, not by the names.

The term “and/or” is used to include all the cases of any combination of the plural items that are subject to the target. For example, “A and/or B” means all three cases of “A”, “B”, “A and B”.

When a component is referred to as “connected” or “linked” to another component, it may be directly connected to or linked to that another component, but it should also be understood that there may be further another component therebetween.

The terms used in the present disclosure are used to explain a particular embodiment, and are not intended to limit the present disclosure. A singular term in the present disclosure includes a plural term unless it is contextually, clearly means a singular form. In the present disclosure, the terms such as “include” or “have” are to specify that there are features, numbers, steps, operations, components or parts described in the present disclosure, or combinations thereof, and It should be understood that the presence or the possibility of addition of numbers, steps, operations, components, part, or combinations thereof are not excluded in advance.

Unless defined differently, all the terms used here, including technical or scientific terms, have the same meaning as commonly understood by those who have normal knowledge in the technical field to which the present disclosure belongs. Terms such as what are commonly used in the dictionary should be interpreted as having the meaning of the context of the relevant technology, and are not interpreted as an ideal or excessively formal meaning unless defined clearly in the present disclosure.

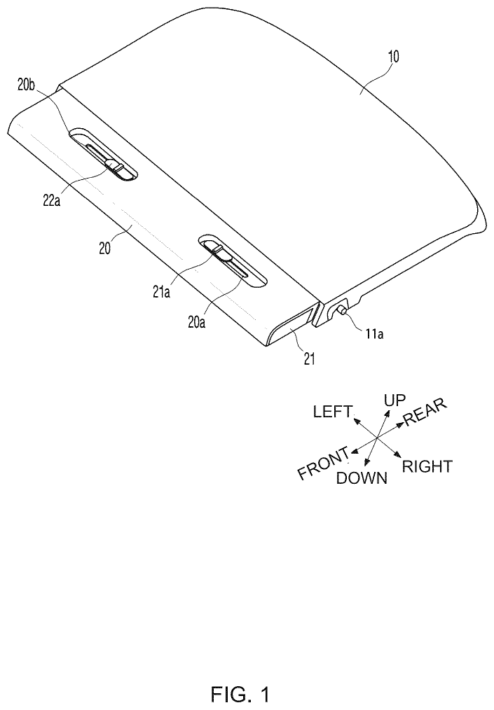

Hereinafter, a covering shelf according to one embodiment of the present disclosure will be described in detail with reference to FIGS. 1 to 4.

First, in FIG. 1, the forward/backward direction, left/right direction, and up/down direction correspond to the respective corresponding directions with respect to the vehicle. These directional definitions are for convenience of explanation only and do not limit the present embodiment.

The covering shelf of the present embodiment is supported and installed in a position that is spaced apart by a set height from the floor in the rear space of the rear seat 2 in the vehicle, and includes a main body 10 and a flap 20.

The main body 10 is formed by extending a set length in the forward, backward, left, and right directions.

Further, the main body 10 is installed inside the vehicle and divides the space behind the rear seat 2 into upper and lower sections.

In this embodiment, the main body 10 has a strength sufficient to be able to place and store an item of a predetermined weight or less thereon, but the embodiment is not necessarily limited to this example.

Additionally, the main body 10 may be rotatably installed in the vehicle interior, for example, on the luggage side trim 1.

To this end, the main body 10 includes the hinge protrusions 11a and 11b to both left and right.

Additionally, the main body 10 is removably mounted and supported on the luggage side trim 1, and thus may be removed from the luggage side trim 1 when the covering shelf is not in use.

The flap 20 extends from the main body 10 toward the seat 2 and is rotatably installed on the main body 10.

The length in the front-back direction of the flap 20 may be determined as a length that allows the flap 20 to touch the rear of the backrest of the rear seat 2 when the rear seat 2 is in a fully upright state, i.e., when the tilting angle is 0°.

For rotational connection of the flap 20 to the body 10, a hinge axis 33 is included.

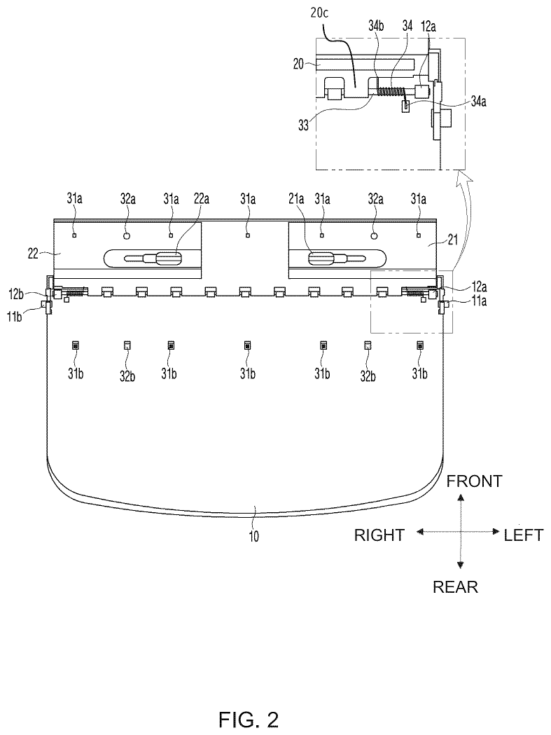

In this embodiment, the hinge axis 33 is installed across the bottom surface of the main body 10 in the left-right direction, as shown in FIG. 2.

For installation of the hinge axis 33, the main body 10 includes a first hinge insertion part 12a and a second hinge insertion part 12b.

The first hinge insertion part 12a and the second hinge insertion part 12b protrude from the bottom surface of the main body 10 and include a groove into which the hinge axis 33 is inserted.

The left end of the hinge axis 33 is inserted into and supported by the insertion groove of the first hinge insertion part 12a, and the right end is inserted into and supported by the insertion groove of the second hinge axis 33.

Additionally, the flap 20 includes a hinge joint 20c to which a hinge axis 33 is coupled.

The hinge joint 20c may include a semicircular curved shape at the rear end of the flap 20.

The flap 20 is rotatably connected to the main body 10 via a hinge axis 33. At this time, as shown in FIG. 1, since the rear end of the flap 20 and the front end of the main body 10 are in contact with each other while the flap 20 is unfolded, the flap 20 is prevented from rotating in the opposite direction to its rotational direction about the hinge axis 33.

Additionally, in order to ensure that the flap 20 is maintained in such an unfolded state, a torsion spring 34 is included as an elastic means that provides elastic restoring force against the rotation of the flap 20.

Referring to FIG. 2, the torsion spring 34 is wound and installed in a spiral shape around a hinge axis 33, one end 34a of the spiral coil is supported by the main body 10 to prevent rotation, and the other end 34b contacts the flap 20 and rotates together.

Accordingly, when the flap 20 is rotated about the main body 10, the other end 34b of the torsion spring 34 is rotated together, and accordingly, elastic restoring force is exerted on the flap 20 by the spiral coil.

As shown in FIG. 2, the torsion spring 34 is provided on each of the left and right sides.

Additionally, the flap 20 includes a first extension part and a second extension part that may be extended in the left and right directions.

The first extension part includes a first extension panel 21 which may be coupled to the left bottom surface of the flap 20, and slide in the left direction to be able to be withdrawn and exit. Further, the first extension part is fixed to the first extension panel 21 and includes a first lever 21a that penetrates a first slot 20a described later and is exposed to the upper surface of the flap 20.

The second extension part includes a first extension panel 22 which may be coupled to the right bottom surface of the flap 20, and slide in the right direction to be able to be withdrawn and inserted. Further, the second extension part is fixed to the second extension panel 22 and includes a second lever 22a that penetrates a second slot 20b described later and is exposed to the upper surface of the flap 20.

A first slot 20a in the form of a long hole extending in the left-right direction is formed on the left part of the flap 20, and a second slot 20b of the same shape is formed on the right side of the flap 20.

In a state like FIG. 1, the user may move the first lever 21a to the left to withdraw the first extension panel 21 in the left direction, and move the second lever 22a to the right to withdraw the second extension panel 22 in the right direction.

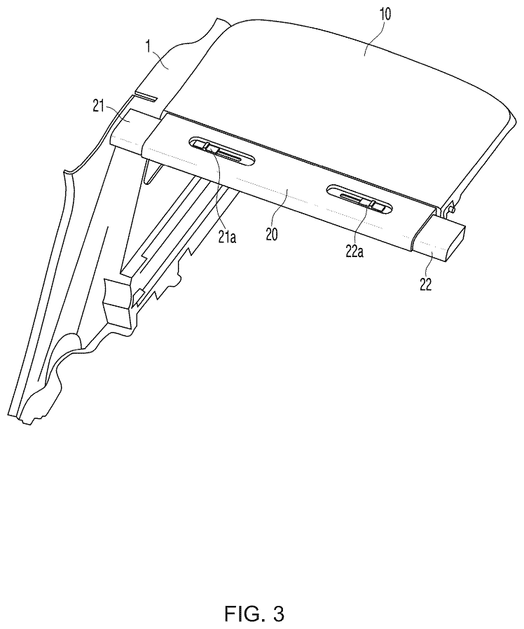

FIG. 3 illustrates a state in which the covering shelf of the present embodiment is installed in a vehicle and shows a state in which the first extension panel 21 and the second extension panel 22 are withdrawn and block the space with the luggage side trim 1. For convenience, only one luggage side trim 1 is shown in FIG. 3, but a luggage side trim of the same structure may be installed on the opposite side as well.

Referring to FIG. 3, the luggage side trim 1 defines the side boundary for the rear loading space of the rear seat 2. The luggage side trim 1 may include a protrusion 1a protruding into the rear space, and the main body 10 of the covering shelf is flat with the upper surface of the protrusion 1a.

In addition, the first extension panel 21 and the second extension panel 22 are withdrawn to the front of the protrusion 1a, and have a flat shape and structure with the upper surface of the protrusion 1a in the withdrawn state.

The flap 20 may be folded by rotating 180° from a fully unfolded state to overlap the lower surface of the main body 10, and at this time, a fixing means is included to maintain the flap 20 in the folded state.

Referring again to FIG. 2, the fixing means includes a push-push latch (31a and 31b) and a magnetic fixing means (32a and 32b).

The push-push latch (31a and 31b) is a well-known latch, also called a DC latch, and includes a gripper 31b and a hooking rod 31a.

In this embodiment, the gripper 31b is installed on the lower surface of the main body 10, and the hooking rod 31a is installed at a position corresponding to the gripper 31b on the lower surface of the flap 20, but the embodiment is not necessarily limited to this example. In other words, the gripper 31b may also be installed on the flap 20, and the hooking rod 31a may also be installed on the main body 10.

As the hooking rod 31a is inserted while pressing the center of the gripper 31b, a gripping movement of the gripper 31b is induced and the hooking rod 31a is gripped. In this state, when the hooking rod 31a is pressed again, the hooking rod 31a is inserted and causes the gripping of the gripper 31b to be released, thereby causing the hooking rod 31a to be released from the gripping. The push-push latch (31a and 31b) is well known, so further detailed description is omitted.

Meanwhile, in this embodiment, the magnetic fixing means (32a and 32b) includes a magnet 32b installed on the lower surface of the main body 10, and a magnet or magnetic body 32a at a corresponding position on the lower surface of the flap 20. Conversely, the magnet 32b may also be installed on the lower surface of the flap 20, and the magnet or magnetic body 32a may also be installed at the corresponding position on the lower surface of the main body 10.

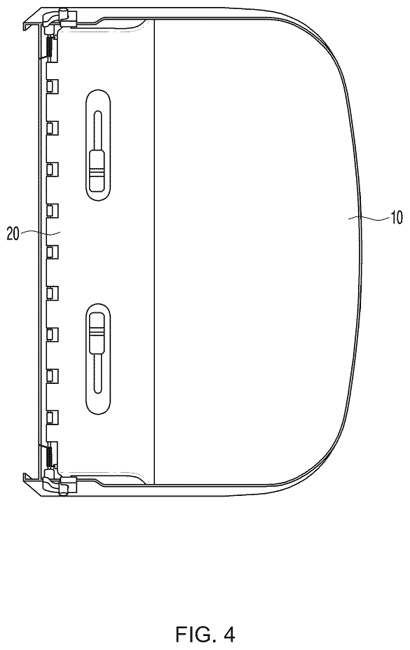

FIG. 4 illustrates a state in which the flap 20 is completely folded and positioned to overlap the lower surface of the main body 10, and is fixed by a fixing means.

Accordingly, the user may install and use the covering shelf inside the vehicle with the flap 20 folded as shown in FIG. 4, and may also remove the covering shelf and store the covering shelf in a folded state as shown in FIG. 4.

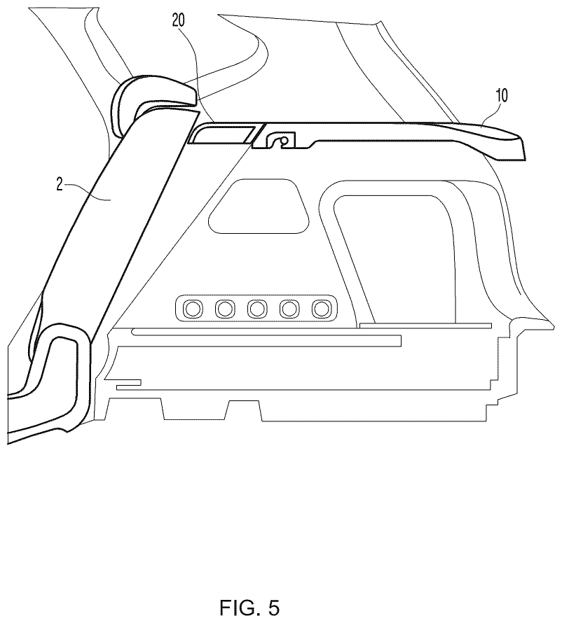

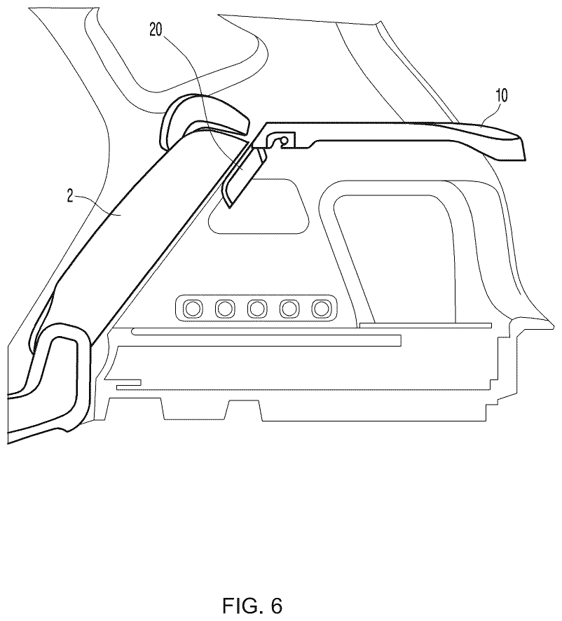

FIGS. 5 and 6 illustrate the use states of the covering shelf of the present embodiment, which will be described below.

FIG. 5 shows a state where the tilting angle of the rear seat 2 is 0°, i.e., a fully upright state.

Referring to FIG. 5, it may be seen that the covering shelf has its flap 20 fully unfolded, and the space with the rear seat 2 is covered by the flap 20.

At this time, when the backrest of the rear seat 2 is tilted, the flap 20 is pressed by the backrest and rotated, as shown in FIG. 6. The flap 20 may maintain contact with the rear of the backrest due to the restoring force of the torsion spring 34 when pressed by the backrest.

When the backrest of the rear seat 2 in the state of FIG. 6 returns to the upright state as in FIG. 5, the flap 20 returns to its original position by the restoring force of the torsion spring 34.

Meanwhile, in this embodiment, the main body 10 and the flap 20 may be injection molded using engineering plastic, but the embodiment is not necessarily limited to this example.

While the disclosure has been described in connection with certain embodiments, it will be understood that it is not intended to limit the invention to those particular embodiments. On the contrary, it is intended to cover all alternatives modifications, and equivalents included within the spirit and scope of the disclosure as defined by the appended claims.

1. A covering shelf configured to be supported in a position spaced apart by a predetermined height from a floor in a rear space behind a rear seat in a vehicle, the covering shelf comprising:
a main body configured to be extended in forward, backward, left, and right directions to divide the rear space into upper and lower parts; and
a flap extending from the main body toward the rear seat, and the flap being rotatably mounted on the main body.

2. The covering shelf of claim 1, further comprising a hinge positioned in the main body and rotatably supporting the flap.

3. The covering shelf of claim 2, further comprising an elastic means configured to provide a restoring force as the flap rotates.

4. The covering shelf of claim 3, wherein the elastic means is wound in a spiral shape around the hinge, one end of the elastic means being supported by the main body to prevent rotation, and the other end of the elastic means including a torsion spring that is configured to rotate together with the flap.

5. The covering shelf of claim 1, wherein the flap includes at least one extension part configured to be drawn in and out in the left or the right direction from the flap.

6. The covering shelf of claim 5, wherein the at least one extension part includes a first extension part configured to be drawn in and out in a first direction from the flap, and second extension part configured to be drawn in and out in a second direction from the flap, the second direction being opposite the first direction.

7. The covering shelf of claim 5, wherein the flap includes a slot extending in the left or the right direction, and the at least one extension part includes a lever exposed through the slot.

8. The covering shelf of claim 1, wherein the flap further includes a fixing means configured to fix the flap in a state such that the flap is rotated under the main body and folded.

9. The covering shelf of claim 8, wherein the fixing means includes a push-push latch including a gripper positioned at one of the main body and the flap, and a hooking rod positioned at an other of the main body and the flap, the hooking rod configured to be gripped or released by the gripper.

10. The covering shelf of claim 8, wherein the fixing means includes a magnet positioned at one of the main body and the flap, and a magnet or magnetic body positioned at an other of the main body and the flap.

11. The covering shelf of claim 1, wherein the main body includes a hinge protrusion that is rotatably connected to a vehicle body inside the vehicle in both the left and the right directions.

12. A vehicle comprising a covering shelf supported in a position spaced apart by a predetermined height from a floor in a rear space of a seat inside a vehicle,
wherein the covering shelf comprises:
a main body extending in forward, backward, left, and right directions to divide the rear space into upper and lower parts; and
a flap extending from the main body toward the seat and rotatably mounted on the main body, the flap including at least one extension part configured to be drawn in and out in the left or the right direction.

13. The vehicle of claim 12, wherein the at least one extension part includes a first extension part configured to be drawn in and out in a first direction from the flap, and second extension part configured to be drawn in and out in a second direction from the flap, the second direction being opposite the first direction.

14. The vehicle of claim 12, wherein the flap includes a slot extending in the the left or the right direction, and the at least one extension part including a lever exposed through the slot.

15. The vehicle of claim 12, further comprising a luggage side trim configured to define a boundary surface at one side of the rear space and including a protrusion protruding toward an inside of the rear space,
wherein the covering shelf is positioned flat with an upper surface of the protrusion.

16. The vehicle of claim 15, wherein the extension part is drawn out to a front side of the protrusion flat with an upper surface of the protrusion.

17. The vehicle of claim 12, wherein the seat includes a tiltable backrest.
